(19) United States
(12) Patent Application Publication
(10) Pub. No.: US 2009/0071572 A1
(43) Pub. Date: Mar. 19, 2009

(54) ALLOY MATERIAL, A MAGNETIC MATERIAL, A MANUFACTURING METHOD OF A MAGNETIC MATERIAL, AND A MAGNETIC MATERIAL MANUFACTURED BY THE MANUFACTURING METHOD

(75) Inventors: Asaya Fujita, Miyagi (JP); Shun Fujieda, Miyagi (JP); Kazuaki Fukamichi, Miyagi (JP); Akiko Saito, Kanagawa (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOHOKU UNIVERSITY, Sendai-shi (JP)

(21) Appl. No.: 12/209,624

(22) Filed: Sep. 12, 2008

(30) Foreign Application Priority Data
Sep. 13, 2007 (JP) 2007-238255

(51) Int. Cl. C22F 1/02; H01F 1/01

(52) U.S. Cl. 148/121; 148/301

(57) ABSTRACT

The alloy material having fine grain size, which is suitable for the mass-production, the magnetic material of bulk having single phase and homogeneous composition and manufacturing method of them are offered. The alloy material comprises a plurality of phases different in composition, the grain size of each phase is 20 μm or less, and the composition as a whole is equal to an NaZn₁₃ type La(FeₓSi₁₋ₓ)₁₃ compound. When the alloy material is heat treated, various kinds of elements are sufficiently diffused in a short time, and magnetic material comprising an La(FeₓSi₁₋ₓ)₁₃ compound having an NaZn₁₃ type crystal structure of a single phase and homogeneous composition can be efficiently obtained.

### CROSS-REFERENCE TO RELATED APPLICATION

This application is based upon and claims the benefit of priority from the prior Japanese Patent Application No. 2007-238255, filed Sep. 13, 2007, the entire contents of which are incorporated herein by reference.

### BACKGROUND OF THE INVENTION

Refrigerators not using ozone-depleting chlorofluorocarbon gas are now being replaced with the conventional ones for the purpose of preservation of global environment, but this measure is not sufficient in the aspect of global warming and energy efficiency.

In recent years, the concept of magnetic refrigeration using solid refrigerant materials has been attracting public attention for realize high efficiency without green-house effect. As magnetic compounds that make magnetic refrigeration possible, an La(FeₓSi₁₋ₓ)₁₃ compound having an NaZn₁₃ type crystal structure and an La_{1-z}R_{z}(FeₓSi_{y}TM_{1-x-y})₁₃ compound (R: Ce, Pr, Nd, TM: Al, Mn, Co, Ni, Cr) the characteristics of which are controlled by partial substitution of La(FeₓSi₁₋ₓ)₁₃ compound are known (JP-A-2003-096547 (the term “JP-A” as used herein refers to an “unexamined published Japanese patent application”) and JP-A-2002-356748).

The La(FeₓSi₁₋ₓ)₁₃ compounds having an NaZn₁₃ type crystal structure show paramagnetic-ferromagnetic thermal-induced 1st-order transition at Curie temperature. Further, the compounds also show magnetic-field-induced 1st-order paramagnetic-ferromagnetic transition in the paramagnetic state just above the Curie temperature, that is, itinerant-electron metamagnetic (IEM) transition.

Since magnetic moment greatly changes with transition, the compound of the invention shows giant magnetostriction and magnetocaloric effect. Therefore, an NaZn₁₃ type La(FeₓSi₁₋ₓ)₁₃ compound and an La_{1-z}R_{z}(FeₓSi_{y}TM_{1-x-y})₁₃ (R: Ce, Pr, Nd, TM: Al, Mn, Co, Ni, Cr) compound the characteristics of which are controlled by partial substitution of the La(FeₓSi₁₋ₓ)₁₃ compound can be applied to actuators or Refrigerators as a giant magnetostrictive material or a magnetic refrigerant.

NaZn₁₃ type La(FeₓSi₁₋ₓ)₁₃ and La_{1-z}R_{z}(FeₓSi_{y}TM_{1-x-y})₁₃ compounds have been manufactured hitherto by casting each element by an arc melting method, and then homogenizing heating treatment of the cast alloy.

However, since cast alloys obtained by an arc melting method contain phases having large grains, atomic interdiffusion of each element does not completely even when heat treatment is performed and it is difficult to obtain a bulk magnetic material of homogeneous composition consisted of a single NaZn₁₃-type structure phase. That is, an arc melting method is unfit for mass production.

### SUMMARY OF THE INVENTION

The invention provides an alloy material comprising of a plurality of phases different in composition, the grain size of each phase being 20 μm or less, and the composition ratio as a whole being equal to an NaZn₁₃ type La(FeₓSi₁₋ₓ)₁₃ compound (provided that 0.80≦x≦0.90) or an La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio).

The invention can also provide an alloy material that is a bulk material and the minimum value of the outside dimension of the bulk material is 1.0 mm or more.

The invention further provides a manufacturing method of a magnetic material using, as the raw material, an alloy material comprising of a plurality of phases different in composition, the grain size of each phase being 20 μm or less, and the composition ratio as a whole being equal to an NaZn₁₃ type La(FeₓSi₁₋ₓ)₁₃ compound (provided that 0.80≦x≦0.90) or an La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio), which comprises a heat treating process of heating the base material in vacuo or in inert gas to make a thermal equilibrium state of the phase of NaZn₁₃-type crystal structure compound.

The invention still further provides a manufacturing method of the magnetic material comprising a process of quenching in a deoxidation atmosphere after the heat treating process.

The invention yet further provides a magnetic material manufactured by the above manufacturing method.

In the invention, the grain sizes of a plurality of phases constituting the alloy material are determined according to the following method.

That is, the alloy material in the invention presents an appearance of fine dendritic metallographic structure, and has three phases as typical metallographic structure. Each of these phases is taken in an electron microphotograph as a phase different in brightness, so that the boundary of phases can be easily visually discriminated. When they are taken as a, b and c phases, in connection with the three phases, the grain size of each phase is measured according to the following method.

In the first place, in the electron microphotograph of the cross section of the alloy sample shown in FIG. 2, arbitrary seven points included in phase a (or phase b or phase c) are randomly selected, the largest circles including these points and not including the phase other than phase a (or phase b or phase c) are drawn, and the diameters of the circles are measured. The average value of five points excluding the largest and smallest circles is computed. The above operation is repeated three times, and the average value of the three average values is defined as the size of phase a (or phase b or phase c).

This method is described below using FIG. 9 that is a conceptual figure showing the method of determination of the grain size of the phases contained in an alloy.

FIG. 9 is a pattern diagrams showing the phases in the alloy in the invention, and this alloy in FIG. 9 shows granularity of different hatchings or matrix surrounding these grains. The boundaries of each phase are relatively clearly discriminated as shown in FIGS. 2, 3, 5 and 6.

This method of determining a grain size successively randomly selects seven points in each of these phases. For example, points 9a1, 9a2 . . . 9a7, 9b1, 9b2 . . . 9b7, and 9c1, 9c2 . . . 9c7 are selected, and points 9a1, 9a2 . . . 9a7 are points included in the region of phase a, points 9b1, 9b2 . . . 9b7 are points included in the region of phase b, and points 9c1, 9c2 . . . 9c7 are those included in the region of phase c. The largest circle in the region including these points and not including other phases is drawn, and the diameters of seven circles are measured in every phase, and the average value of five points excluding the circles having the largest and smallest diameters is computed. This operation is repeated three times, and the average value of the three average grain sizes is defined as the average grain size of each phase.

According to the invention, it becomes possible to realize mass production of an alloy material suitable for the manufacture of a magnetic refrigerant, and a magnetic material can be obtained by a simple method.

### BRIEF DESCRIPTION OF THE DRAWINGS

FIG. 1 is a cross sectional view of the principal part showing the fundamental construction of a high-frequency induction melting furnace for use in the manufacture of an alloy material in the mode for carrying out the invention.

FIG. 2 is a photographic chart of the metallographic structure of an alloy sample observed with an electron microscope for explaining the examples of the invention.

FIG. 3 is a photograph of the metallographic structure of a comparative sample observed with an electron microscope for explaining the examples of the invention.

FIG. 4 is the X-ray diffraction pattern of a magnetic material for explaining the examples of the invention.

FIG. 5 is a photographic chart of a metallographic structure of an alloy sample observed with an electron microscope for explaining the examples of the invention.

FIG. 6 is a photographic chart of a metallographic structure of an alloy sample observed with an electron microscope for explaining the comparative examples of the invention.

FIG. 7 is the X-ray diffraction pattern of the magnetic material in the examples of the invention after homogenizing heat treatment.

FIG. 8 is the X-ray diffraction pattern of the magnetic material in the comparative example for explaining the invention after homogenizing heat treatment.

FIG. 9 is a conceptual drawing to explain the method of determining the grain size of each phase having a different metallographic structure contained in an alloy of the invention.

### DETAILED DESCRIPTION OF THE EMBODIMENTS

That is, according to the invention, since the grain size of each phase of an alloy material comprising of a plurality of phases forms metallographic structure as fine as 20 μm or less, various elements sufficiently interdiffuse in a short time when the alloy material is heat treated. Accordingly, when this alloy material is used as a base material, an La(FeₓSi₁₋ₓ)₁₃ compound (provided that 0.80≦x≦0.90), or an La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio), having a single phase of NaZn₁₃-type crystal structure and homogeneous in composition, can be formed efficiently.

Here, when the composition as a whole is La(FeₓSi₁₋ₓ)₁₃, and x is greater than 0.90, Fe is greatly precipitated even when heat treatment is performed, and a single phase of the La(FeₓSi₁₋ₓ)₁₃ compound having an NaZn₁₃-type crystal structure cannot be obtained. On the other hand, when x is smaller than 0.80, the characteristics of magnetocaloric effect and magnetostriction are largely reduced. Further, in the case where a part of La is substituted with R element such as Ce, Pr or Nd in the above composition, large magnetocaloric effect and giant magnetostriction can also be obtained by adjusting x and z similarly to the above composition. Here, when a part of La is substituted with R element such as Ce, Pr or Nd, an effect of adjusting the temperature range which allows to obtain large magnetocaloric effect and giant magnetostriction to a lower temperature side can be obtained. Further, in the above composition, when a part of Fe or Si is substituted with TM element such as Al, Mn, Co, Ni or Cr to make an La_{1-z}R_{z}(FeₓSi_{y}TM_{1-x-y})₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio), large magnetocaloric effect and giant magnetostriction can also be obtained by adjusting x and z similarly to the above composition. When y is greater than 0.20, the characteristics of magnetocaloric effect and magnetostriction are largely reduced.

As described above, in an alloy material having the composition as a whole being equal to an NaZn₁₃-type La(FeₓSi₁₋ₓ)₁₃ compound (provided that 0.80≦x≦0.90), or an La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio), comprising of a plurality of phases different in composition, and having the grain size of each phase of 20 μm or less, an La(FeₓSi₁₋ₓ)₁₃ compound, or an La_{1-z}R_{z}(FeₓSi_{y}TM_{1-x-y})₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio) having an NaZn₁₃-type crystal structure and large magnetocaloric effect and large magnetostriction can be efficiently formed by heat treatment of the base alloy material.

When the alloy material is a bulk material and the minimum value of the outside dimension of the bulk material is from 1 to 10 mm, the alloy material can be easily handled, and the processability of the obtained bulk magnetic material is also high. The outside dimension of a bulk material means, for example, if the material shape is a rectangular parallel piped, any dimension of a length, a breadth and a height, and if the material shape is a column, it means any dimension of a diameter and a height.

Further, according to the invention, in an alloy material comprising of a plurality of phases different in composition, the grain size of each phase being 20 μm or less, and the composition as a whole being equal to an NaZn₁₃-type La(FeₓSi₁₋ₓ)₁₃ compound (provided that 0.80≦x≦0.90), or an La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio), since the grain size in each phase is fine, various kinds of elements easily interdiffuse between phases in a short time by heat treatment in vacuo or in inert gas, and a thermal equilibrium state of the phase of NaZn₁₃-type crystal structure compound is realized, so that homogenizing treatment is performed to a considerable extent.

Accordingly, the bulk magnetic material of the NaZn₁₃-type La(FeₓSi₁₋ₓ)₁₃ compound (provided that 0.80≦x≦0.90) that is a single phase and homogeneous in the composition, or the La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio) that is a single phase and homogeneous in the composition can be efficiently obtained.

Further, when a process of quenching in a deoxidation atmosphere is performed after the heat treatment process for interdiffusion, the thermal equilibrium state of phase of the NaZn₁₃-type crystal structural is stabilized and crystallized, so that precipitation of different phases can be prevented and a bulk magnetic material having high quality can be obtained.

Further, a magnetic material manufactured by the above manufacturing method can sufficiently exhibit intended giant magnetostriction or large magnetocaloric effect, so that refrigerators or actuators of high efficiency can be realized by use of the bulk magnetic material.

In short, as described above, the invention can solve the problems of the prior art, provide an base alloy material of fine grain sizes suitable for mass production, a manufacturing method of a bulk magnetic material of a single phase and homogeneous in composition, and can provide a magnetic material manufactured by the manufacturing method.

The embodiments of the invention will be described with referring to the accompanying drawings.

An alloy material in the invention consists of a plurality of phases different in composition, the grain size of each phase is 20 μm or less, and the composition as a whole is equal to an NaZn₁₃-type La(FeₓSi₁₋ₓ)₁₃ compound (provided that 0.80≦x≦0.90), or an La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio).

For the purpose of manufacturing an NaZn₁₃-type La(FeₓSi₁₋ₓ)₁₃ compound (provided that 0.80≦x≦0.90), or an La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio), which is expected for realization of a giant magnetostriction material and a magnetic refrigerant, in high-yield, the present inventor has tried to manufacture an NaZn₁₃-type La(FeₓSi₁₋ₓ)₁₃ compound according to a high-frequency induction melting method capable of large-scale production.

In particular, for obtaining a bulk magnetic material of a single phase and homogeneous in composition, the inventor tried to rapidly quench a molten metal in a casting mold by means of a high-frequency induction melting method, and examined the relation between the quenching speed, the grain sizes of the base alloy materials and the homogenizing effect in magnetic material by heat treatment.

As a result, an alloy material having the grain size of each phase of 20 μm or less, and the composition as a whole equal to an NaZn₁₃ type La(FeₓSi₁₋ₓ)₁₃ compound (provided that 0.80≦x≦0.90), or an La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio) could be obtained.

Further, the inventor has found that a bulk magnetic material of a single phase and homogeneous in composition can be obtained by homogenizing heat treatment with the alloy material as a base material, thus the present invention has been accomplished.

The alloy material can be manufactured as follows.

In the first place, raw materials of La, Fe and Si are prepared in the prescribed amounts so as to obtain the composition of La(Fe_{0.88}Si_{0.12})₁₃.

Subsequently, the prepared raw materials are melted in a high-frequency induction melting furnace.

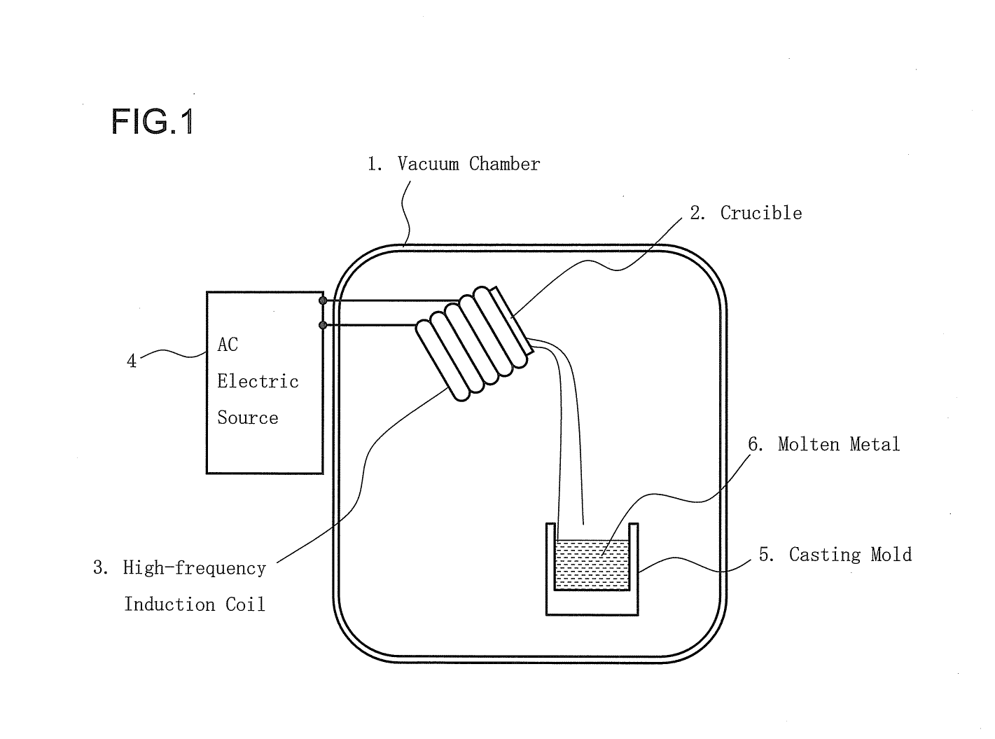

FIG. 1 is a cross sectional view of the principal part showing the fundamental construction of a high-frequency induction melting furnace. In FIG. 1, 1 is a vacuum chamber, 2 is a crucible for holding a material to be heated made of CaO which is provided so as to be capable of taking out and putting in the chamber 1, 3 is a high-frequency induction coil for heating material which is located around crucible 2, 4 is an AC electric source for supplying high-frequency current to the coil 3, and 5 is a copper casting mold for quenching a molten metal 6 supplied from crucible 2, which has a cavity of a shape to be molded.

The specific operation of melting process is as follows. First, crucible 2 containing a raw material weighing capacity of a prescribed composition is set in the coil 3. After vacuum chamber 1 is evacuated to 20 Pa or so, inert gas, e.g., Ar gas, is introduced to a degree of 0.005 MPa or so. High-frequency current of 9 kHz is supply from AC electric source 4 to coil 3, and the raw materials are heated to a temperature above the melting points of each materials (at which each raw material is sufficiently dissolved), e.g., 1,837 K, at a rate of about 30 K a minute to obtain a stable molten metal. By the introduction of inert gas, evaporation of each element can be reduced.

Subsequently, when a molten metal is sufficiently mixed in fusion, supply of high-frequency current is stopped, and the molten metal in crucible 2 is supplied to mold 5 and quenched to obtain a bulk cast alloy. The bulk casting alloy is formed of a plurality of phases different in composition and the grain size of each phase also varies. The grain size of each phase is fined by rapid quenching to become 20 μm or less, and the composition as a whole attains to La(Fe_{0.88}Si_{0.12})₁₃.

For rapidly performing quenching, the thermal conductivity of the material of casting mold 5 is preferably higher, for example, a copper mold is preferred. In addition, the material of mold 5 is preferably such a material that the mold itself does not melt by the supply of a molten metal of a high temperature. As the shape of a casting alloy, the greater the surface area, the greater is the radiation performance, and the rapider is the quenching of the molten metal, so that a tabular shape is preferred to a columnar or spherical shape if the volume is the same. Further, when a molten metal and a casting mold attain thermal equilibrium, the molten metal is quenched to a lower temperature, so that a casting mold large in heat capacity is preferred.

A magnetic material can be manufactured as follows with the alloy material as a base material.

A cast alloy is taken out of a casting mold, set to an electric furnace, and subjected to homogenizing heat treatment at a temperature at which the phase of the NaZn₁₃-type La(Fe_{0.88}Si_{0.12})₁₃ compound becomes a thermal equilibrium state, e.g., 1,323 K. The period of homogenizing heat treatment depends upon the size of a metallographic structure of base alloy, for example, if the size of the structure of each phase is 20 μm or so, the period is about 10 days or so. The heat treatment temperature at which the phase of the NaZn13-type crystal structure is to be in a thermal equilibrium state can be applicable, therefore, it is not necessary to restrict the heat treatment time to 10 days, and it can be determined by considering heat treatment temperature and the size of the metallographic structure of each phase of base alloy. That is, when the temperature is to be in the range that the phase of the NaZn13-type crystal structure is in a thermal equilibrium state, the higher temperature of the heat treatment, the shorter time of the heat treatment can be required. On the other hand, it is required the heat treatment time longer with the increase in the size of the metallographic structure, and it is possible to set the heat treatment time shorter with the decrease in the size of the metallographic structure of base alloy.

The homogenizing heat treatment is performed according to the following procedure. In the first place, a sample of casting alloy is put in a silica tube and exhausted from the open end, for preventing oxidation during the homogenizing heat treatment. After the inside of the silica tube is vacuumed to 5×10⁻⁵ Torr or less, (or after the silica tube is vacuumed to 5×10⁻⁵ Torr or less, inert gas is introduced to the pressure lower than an atmospheric pressure and sealed) the silica tube is sealed.

The silica tube in which the sample is sealed is subjected to heat treatment in an electric furnace at 1,323 K for 10 days.

After homogenizing heat treatment, the silica tube sealing the sample is taken out of the electric furnace, and quenched in ice water for 2 hours or so. After the sample is cooled to around room temperature, the sample is taken out of the silica tube.

When the sample is cooled in ice water, the NaZn₁₃-type La(Fe_{0.88}Si_{0.12})₁₃ phase formed by the heat treatment is stabilized, so that the precipitation of different phases can be prevented. Further, for preventing oxidation of the sample, the sample is taken out of the silica tube after the sample is cooled to near room temperature. When inert gas is introduced into the silica tube, the effect of rapid quenching is conspicuous and also cooling time to room temperature region can be shortened.

When the grain size of each phase of the casting alloy is 20 μm or less, the metallographic structure is fine and the diffusion distances of the elements of each phase for the homogenizing are short, so that a bulk material of an La(Fe_{0.88}Si_{0.12})₁₃ compound having a single phase of an NaZn₁₃-type crystal structure and homogeneous composition can be obtained by homogenizing heat treatment. When the grain size of each phase of the casting alloy is 10 μm or less, the diffusion distances of the elements of each phase are shorter, so that a bulk material of an La(Fe_{0.88}Si_{0.12})₁₃ compound having a single phase of an NaZn₁₃-type crystal structure and homogeneous composition can be obtained by homogenizing heat treatment for a short time.

On one hand, when the grain size of each phase of the casting alloy exceeds 20 μm, since the metallographic structure is coarse, very long period is required to interdiffuse each kinds of elements in each phase for homogeneity, or even when heat treatment is carried out for a long term, it becomes difficult to accomplish sufficient interdiffusion of each kinds of elements in a wide area and formation of some thermal equilibrium phases at local area is stabilized, so that it is difficult to form a single phase and homogeneous NaZn₁₃-type La(Fe_{0.88}Si_{0.12})₁₃ compound.

In the above embodiment, the alloy material having the composition as a whole equal to that of (the NaZn₁₃ type) La(Fe_{0.88}Si_{0.12}) 13 (compound) and the bulk magnetic material of the La(Fe_{0.88}Si_{0.12})₁₃ compound are obtained, but the alloy material and the bulk magnetic material are not restricted thereto. An alloy material having a grain size of each phase of 20 μm or less can be obtained by preparing each raw material in a prescribed amount so that the composition as a whole is equal to an La(FeₓSi₁₋ₓ)₁₃ compound (provided that 0.80≦x≦0.90), or an La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio), and applying the same processes as above.

Further, by using these alloy materials as base materials, an La(FeₓSi₁₋ₓ)₁₃ compound (provided that 0.80≦x≦0.90) or an La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio) having a single phase of NaZn₁₃-type crystal structure and homogeneous composition can be obtained.

Since homogenizing heat treatment is carried out at each temperature that the phase of the NaZn13-type crystal structure of the La(FeₓSi₁₋ₓ)₁₃ compound (provided that 0.80≦x≦0.90) and the La_{1-z}R_{z} (FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio), become a thermal equilibrium state, the conditions of heat treatment is slightly different depending on the kinds and amounts of R elements.

Incidentally, in the above method, by using the bulk casting alloy having the composition as a whole equal to that of the La(Fe_{0.88}Si_{0.12})₁₃ compound obtained by melting the raw materials weighed in a prescribed composition and quenching the molten metal, it is also applicable effectively, after a process that the bulk casting alloy is chopped into small pieces, to set the casting alloy or the small pieces mentioned above to an electric furnace and perform homogenizing heat treatment at a temperature at which that the phase of the NaZn₁₃-type La(Fe_{0.88}Si_{0.12})₁₃ compound becomes a thermal equilibrium state.

According to each of the above embodiments, it is possible to manufacture the bulk material of the La(FeₓSi₁₋ₓ)₁₃ compound (provided that 0.80≦x≦0.90) or the La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio), having a single phase of NaZn₁₃-type crystal structure and homogeneous composition, high-yield and stably in a large-scale. Accordingly, these materials as materials for magnetic refrigerant or magnetostriction materials can contribute to the practical use of high-efficiency magnetic refrigerators and actuators.

### EXAMPLE

### Example 1 And Comparative Example 1

### Manufacture of Alloy Sample

Alloy samples are manufactured by means of a high-frequency induction melting method by melting La, Fe and Si raw materials so that the compositions become La(Fe_{0.88}Si_{0.12})₁₃. The characteristics of the casting mold used in the manufacture of the alloy sample and the characteristics of the alloy sample obtained thereby are shown in Table 1 below. The characteristics of the iron mold used in the Comparative Example and the characteristics of the alloy sample obtained thereby are also shown together.

TABLE 1

| | | | Comparative | |
|---|---|---|---|---|
| | Example | | Example | |
| Material of Mold | Cu | | Fe | |
| Heat Conductivity | 403 | W/mK | 84 | W/mK |
| (Thermal Conductivity) | | | | |
| of Mold | | | | |
| Heat Capacity | 10,600 | J/K | 2,000 | J/K |
| of Mold | | | | |
| Shape of Sample | Tabular | | Columnar | |
| | (length × breadth × | | (diameter × | |
| | height, unit: mm) | | height, unit: mm) | |
| | 10 × 120 × 100 | | φ30 × 130 | |
| Surface Area | 284 | cm² | 137 | cm² |
| of Sample | | | | |

As shown in Table 1, a copper mold five times higher than the iron mold in thermal conductivity is used. The heat capacity of the mold used in the manufacture of the alloy sample in the Example is 10,600 J/K, which is five times the heat capacity of the mold used in the Comparative Example. That is to say, in the manufacture, the molten metal cast of the alloy sample in the Example is cooled rapidly to lower temperature as compared with the cast sample in the Comparative Example.

Further, the shape of the alloy sample in the Example is thin tabular, and the surface area of the sample is 284 cm². On the other hand, the shape of the sample in the Comparative Example is columnar and the surface area of the sample is 137 cm². Accordingly, the alloy sample in the Example is quenched more rapidly than the sample in the Comparative Example.

### Evaluation of Cast Alloy Sample:

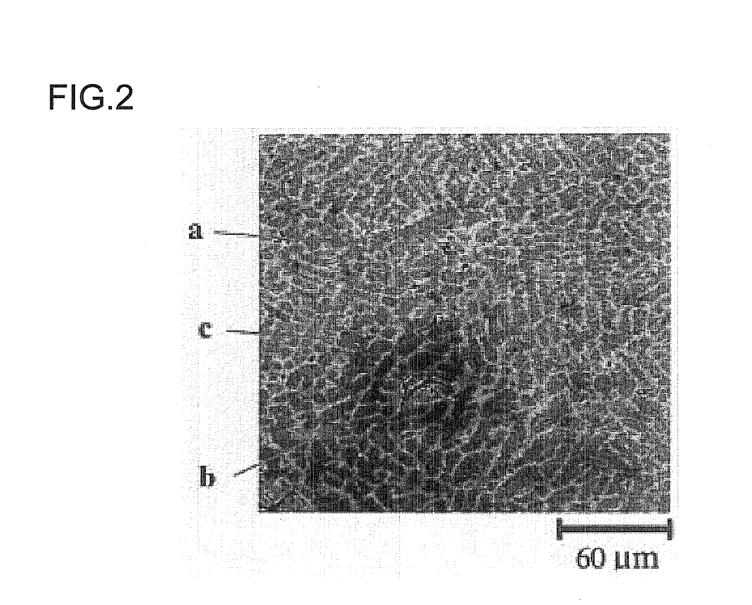

The photographic chart of the structure of the alloy sample in the Example observed with an electron microscope is shown in FIG. 2. As shown in the photographic chart of the structure in FIG. 2, three different phases of a, b and c are observed in the microstructure of the alloy sample.

The concentrations of each element in phase a, phase b and phase c, and the ideal concentrations of each element of the NaZn₁₃-type La(Fe_{0.88}Si_{0.12})₁₃ phase are shown in Table 2 below. The alloy sample consists of phase a where the concentration of Fe is higher and the concentrations of La and Si are lower compared with the NaZn₁₃-type La(Fe_{0.88}Si_{0.12})₁₃ phase, phase b where the concentrations of La and Si are higher and the concentration of Fe is lower compared with the NaZn₁₃-type La(Fe_{0.88}Si_{0.12})₁₃ phase, and phase c that is the NaZn₁₃-type La(Fe_{0.88}Si_{0.12})₁₃ phase.

TABLE 2

| | Phase | Phase | Phase | Phase |
|---|---|---|---|---|
| | a | b | c | La(Fe_{0.88}Si_{0.12})₁₃ |
| Concentration | 0.2 | 26.2 | 7.0 | 7.1 |
| of La (at. %) | | | | |
| Concentration | 92.9 | 43.0 | 77.0 | 81.7 |
| of Fe (at. %) | | | | |
| Concentration | 6.9 | 30.8 | 16.0 | 11.1 |
| of Si (at. %) | | | | |

The grain size of each phase of these samples is measured according to the above-described grain size determining method. That is, in connection with three phases of each of a, b and c phases showing fine dendritic metallographic structure, in the electron microphotograph of the cross section of the alloy sample in Example 1 shown in FIG. 2, arbitrary seven points included in phase a (or phase b or phase c) are randomly selected, the largest circles including these points and not including the phase other than phase a (or phase b or phase c) are drawn, and the diameters of the circles are measured. The average value of five points excluding the largest and smallest circles is computed. The above operation is repeated three times, and the average value of the three average values is defined as the size of phase a (or phase b or phase c).

The measured average values of the grain sizes of phase a in the alloy sample in Example 1 shown in FIG. 2 are 6.7 μm, 7.6 μm and 7.8 μm, and the average of these values is 7.4 μm, accordingly the size of the phase is estimated to be about 7 μm. The measured average values of the grain sizes of phase b are 3.3 μm, 2.6 μm and 2.9 μm, and the average of these values is 2.9 μm, accordingly the size of the phase is estimated to be about 3 μm. Since phase c is low (small amount) in content, measurement according to the above method cannot execute, but in the electron microphotograph in the cross section of the alloy sample in Example 1 shown in FIG. 2, the size of phase c observed is obviously smaller than 20 μm.

It can be seen that in connection with the sizes of phases a, b and c in the alloy sample, the size of phase a is about 5 to 10 μm, and phases b and c are also apparently smaller than 20 μm.

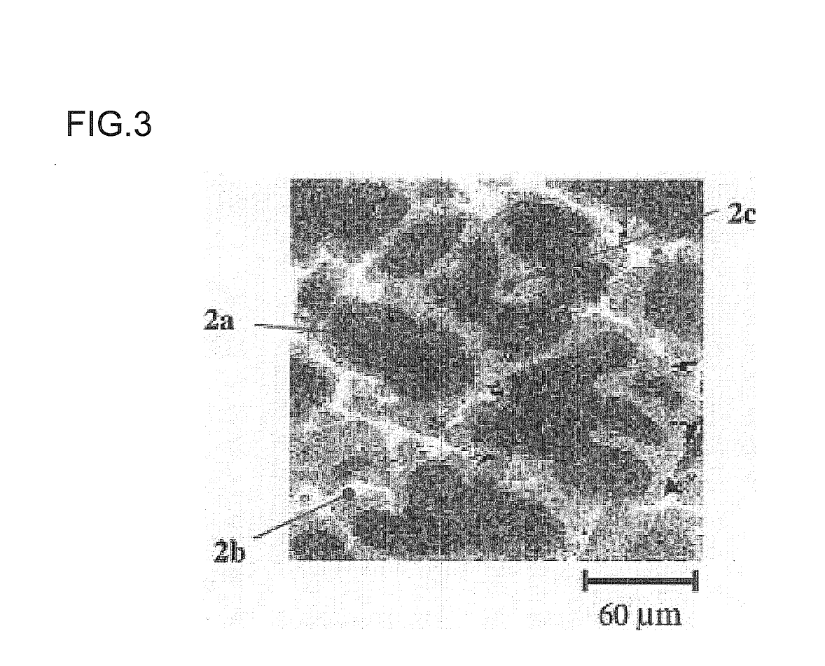

The photograph of the metallographic structure of the alloy sample in Comparative Example 1 observed with an electron microscope is shown in FIG. 3. As shown in the photograph of the structure in FIG. 3, three different phases of 2a, 2b and 2c are observed in the microstructure of the alloy sample in the Comparative Example, but the greater part of the alloy sample in the Comparative Example is phase 2a.

Also with respect to three phases of 2a, 2b and 2c of the alloy sample in Comparative Example 1, the sizes of the phases are measured in the same manner as in the Example by using the electron microphotograph of the cross section of the alloy sample shown in FIG. 3. As a result, the sizes of phases 2a, 2b and 2c are respectively estimated to be about 35 μm, about 11 μm and about 17 μm. The grain sizes of phase 2a in the alloy sample in the Comparative Example are distributed from 25 to 100 μm or so in such a manner, and the size of phase 2a is estimated to be about 30 to 50 μm or so, which is apparently greater than the alloy sample in the Example. Further, it can be seen that phases 2b and 2c in the alloy sample in the Comparative Example are also apparently larger than phases a and b in the alloy sample in the Example.

The concentrations of each element in phases 2a, 2b and 2c, and the ideal concentrations of each element of the NaZn₁₃-type La(Fe_{0.88}Si_{0.12})₁₃ phase are shown in Table 3 below. When compared with the NaZn₁₃-type La(Fe_{0.88}Si_{0.12})₁₃ phase, phase 2a is higher in the concentration of Fe and the concentrations of La and Si are lower. When compared with the NaZn₁₃-type La(Fe_{0.88}Si_{0.12})₁₃ phase, phase 2b is higher in the concentration of La and Si and lower in the concentration of Fe. The concentration of phase 2c is very close to the ideal concentration of each element of the NaZn₁₃-type La(Fe_{0.88}Si_{0.12})₁₃ phase.

TABLE 3

| | Phase | Phase | Phase | Phase |
|---|---|---|---|---|
| | 2a | 2b | 2c | La(Fe_{0.88}Si_{0.12})₁₃ |
| Concentration | 5.4 | 28.0 | 6.8 | 7.1 |
| of La (at. %) | | | | |
| Concentration | 94.3 | 39.4 | 78.3 | 81.7 |
| of Fe (at. %) | | | | |
| Concentration | 0.27 | 32.6 | 14.9 | 11.1 |
| of Si (at. %) | | | | |

As described above, the NaZn₁₃-type La(Fe_{0.88}Si_{0.12})₁₃ phase is hardly contained in the casting samples in Example 1 and Comparative Example 1.

### Manufacture of a Single Phase Magnetic Material:

After that, the casting alloy samples in Example 1 and Comparative Example 1 are subjected to homogenizing heat treatment in vacuo at 1,323 K for 10 days to interdiffuse various kinds of elements, and NaZn₁₃-type La(Fe_{0.88}Si_{0.12})₁₃ compounds are manufactured.

### Evaluation of a Single Phase Magnetic Material:

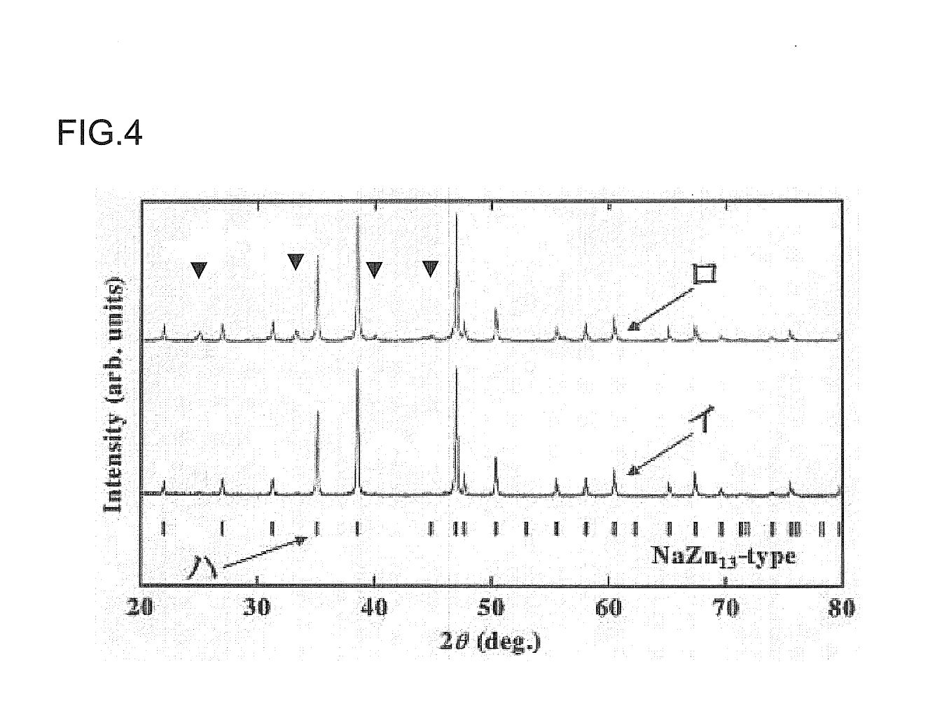

FIG. 4 shows the X-ray diffraction pattern in the Example and the Comparative Example after homogenizing heat treatment.

In FIG. 4, the axis of abscissa shows the incident angle of X-ray, the axis of ordinate shows the relative value of diffraction intensity of X-ray, the curve a shows the X-ray diffraction pattern in the Example, and the curve b shows the X-ray diffraction pattern in the Comparative Example. Further, c shown in spectrum shows the X-ray diffraction pattern of the NaZn₁₃-type crystal structure.

As shown in the curve a, the diffraction pattern in the Example is in good agreement with the diffraction pattern of the NaZn₁₃-type crystal structure, which shows that the sample in the Example is to be a single phase and homogeneous NaZn₁₃-type La(Fe_{0.88}Si_{0.12})₁₃ compound.

On the other hand, as shown in the curve b, in the diffraction pattern in the Comparative Example, diffraction peaks different from those of the NaZn₁₃-type crystal structure are observed at the angle of about 25°, 33°, 40°, and 45° in addition to the diffraction peak of the NaZn₁₃-type crystal structure. This fact shows that phases 2a, 2b and 2c are present in the sample after the homogenizing heat treatment as shown in FIG. 3.

The fact described above shows the following understanding. That is, in the alloy sample in Example 1, since the grain size is as small as 5 to 10 μm and the metallographic structure is fine, the diffusion distance of various kinds of elements is relatively-short so as to homogenize, thereby the NaZn₁₃-type La(Fe_{0.88}Si_{0.12})₁₃ compound is formed easily. As a result, each kinds of elements can be sufficiently diffused by the homogenizing heat treatment at 1,323 K for 10 days, and the single phase of NaZn₁₃-type structure and homogeneous composition of La(Fe_{00.88}Si_{0.12})₁₃ compound can be obtained.

On the other hand, since the metallographic structure is coarse and the grain size is as large as 30 to 100 μm in the alloy sample in the Comparative Example 1, the interdiffusion of various kinds of elements between each phases is not sufficiently performed and stabilized as—they are inhomogeneous even when homogenizing heat treatment is carried out. As a result, a single phase of NaZn₁₃-type structure and homogeneous composition of La(Fe_{00.88}Si_{0.12})₁₃ compound cannot be formed.

### Example 2 and Comparative Example 2

### Manufacture of Alloy Sample

Alloy samples in Example 2 and Comparative Example 2 are manufactured by means of a high-frequency induction melting method in the same manner as in Example 1 and Comparative Example 1 described above by melting La, Fe, Mn and Si raw materials so that the compositions become La_{0.75}Ce_{0.25} (Fe_{0.850}Mn_{0.035}Si_{0.115})₁₃. The casting molds used in Example 2 and Comparative Example 2 are the same as those used in Example 1 and Comparative Example 1. Accordingly, similarly to Example 1 and Comparative Example 1, the alloy sample in Example 2 is more rapidly quenched than the alloy sample in Comparative Example 2.

### Evaluation of Cast Alloy Sample:

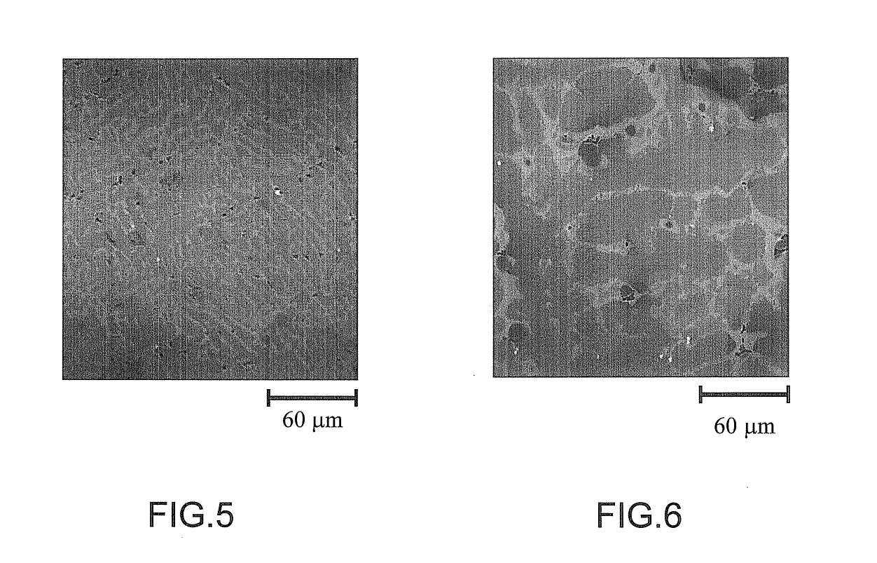

The photographic charts of the metallographic structures of the alloy samples in Example 2 and Comparative Example 2 observed with an electron microscope are shown in FIGS. 5 and 6. The alloy sample in Example 2 shown in FIG. 5 consists of a plurality of phases, and every phase is fine and clearly obviously smaller than 20 μm. On the other hand, it is seen demonstrated that the alloy sample in Comparative Example 2 shown in FIG. 6 has a metallographic structure far greater than the alloy sample in Example 2. As shown in FIG. 6, three different phases of a, b and c are observed in the metallographic structure of the alloy sample in Comparative Example 2. With respect to phases a, b and c, the concentrations of each element in each phase determined by composition analysis of a certain spot are shown in Table 4 below. The ideal concentrations of each element of the La_{0.75}Ce_{0.25}(Fe_{0.850}Mn_{0.035}Si_{0.115}) 13 phase having an NaZn₁₃-type structure are also shown together in Table 4. It has been found that the alloy sample consists of phase a higher in the concentration of Fe and lower in the concentrations of La, Ce, Mn and Si more than the NaZn₁₃-type, phase b higher in the concentrations of La, Ce and Si more than the NaZn₁₃-type La_{0.75}Ce_{0.25} (Fe_{0.850} Mn_{0.035}Si_{0.115}) 13 phase and lower in the concentration of Fe, and phase c that is an NaZn₁₃-type (La, Ce) (Fe, Mn, Si)₁₃ phase. In connection with the alloy sample of the Comparative Example, as a result of the measurement of the grain size of phase a having the largest grain size according to the above-described method, the measured average value is estimated to be 26.1 μm, and greater than 20 μm.

TABLE 4

| | Phase | Phase | Phase | Phase |
|---|---|---|---|---|
| | a | b | c | La_{0.75}Ce_{0.25}(Fe_{0.850}Mn_{0.035}Si_{0.115})₁₃ |
| Concen- | 0.19 | 20.43 | 4.88 | 5.36 |
| tration | | | | |
| of La | | | | |
| (at. %) | | | | |
| Concen- | 0.11 | 10.99 | 2.26 | 1.78 |
| tration | | | | |
| of Ce | | | | |
| (at. %) | | | | |
| Concen- | 89.55 | 32.94 | 78.00 | 78.93 |
| tration | | | | |
| of Fe | | | | |
| (at. %) | | | | |
| Concen- | 3.73 | 2.63 | 3.06 | 3.25 |
| tration | | | | |
| of Mn | | | | |
| (at. %) | | | | |
| Concen- | 6.42 | 33.69 | 11.81 | 10.68 |
| tration | | | | |
| of Si | | | | |
| (at. %) | | | | |

### Manufacture of a Single Phase Magnetic Material:

After that, the alloy samples in the Example and the Comparative Example are subjected to homogenizing heat treatment in vacuo at 1,373 K for 10 days to diffuse various kinds of elements, and NaZn₁₃-type La_{0.75}Ce_{0.25} (Fe_{0.850}Mn_{0.035}Si_{0.115})₁₃ compounds are manufactured.

### Evaluation of a Single Phase Magnetic Material:

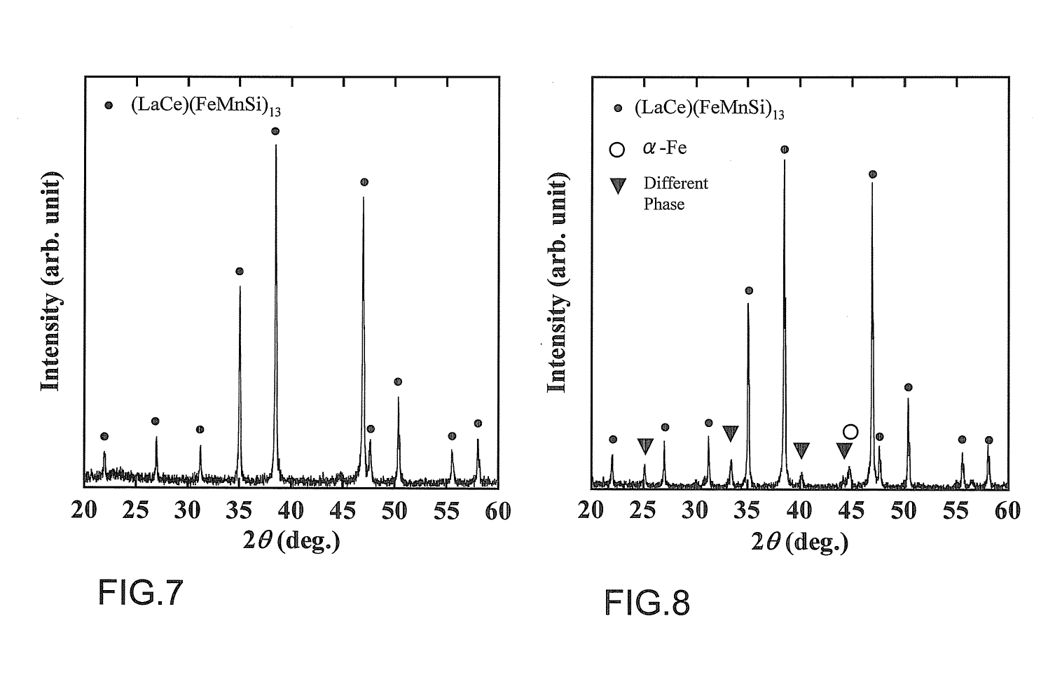

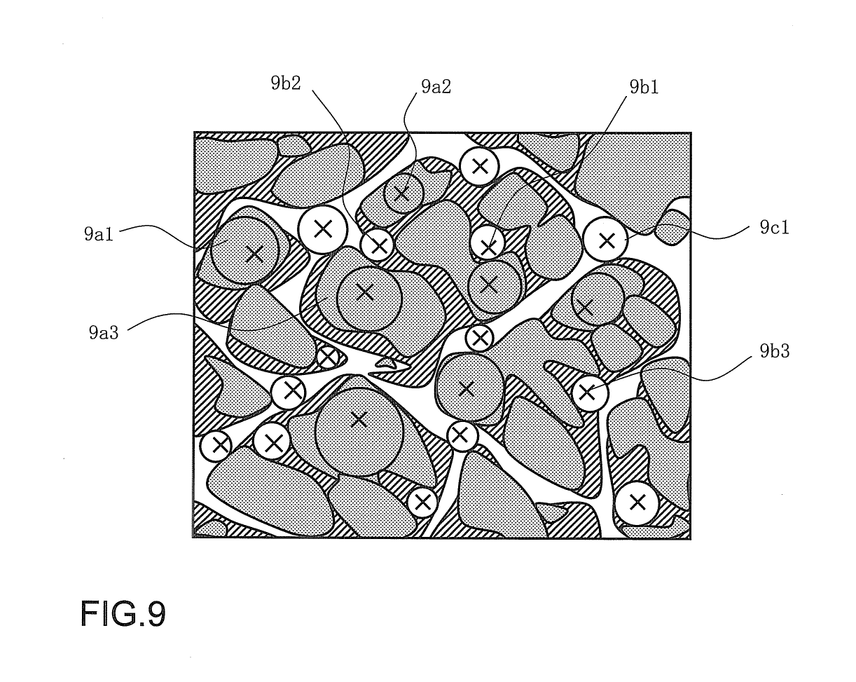

The X-ray diffraction patterns in the Example and the Comparative Example after homogenizing heat treatment are shown in FIGS. 7 and 8.

In FIGS. 7 and 8, the axis of abscissa shows the incident angle of X-ray, and the axis of ordinate shows the relative value of diffraction intensity of X-ray. In the diffraction pattern of the Example shown in FIG. 7, almost all of the diffraction peaks correspond to the X-ray diffraction pattern of the NaZn₁₃-type crystal structure shown by , and it has been shown that almost a single phase of (La, Ce) (Fe, Mn, Si) 13 phase having an NaZn₁₃-type crystal structure is formed. On the other hand, in the X-ray diffraction pattern of the sample in the Comparative Example shown in FIG. 8, in addition to the X-ray diffraction pattern corresponding to the NaZn₁₃-type crystal structure shown by , an α-Fe phase shown by ◯, and diffraction peaks different from that of the NaZn₁₃-type crystal structure (shown by ▾) are observed at the angle of about 25°, 33°, 40°, and 45°. That is, a single phase of the NaZn₁₃-type crystal structure (La, Ce) (Fe, Mn, Si)₁₃ cannot be formed even after the homogenizing heat treatment, which shows that some different phases are present.

As has been shown above, similarly to the case of the composition of La(Fe_{0.88}Si_{0.12})₁₃, in the case of the composition of La_{0.75}Ce_{0.25} (Fe_{0.850}Mn_{0.035}Si_{0.115}) 13 also, when the grain size in the metallographic structure of the base alloy sample is 20 μm or less, a compound of a single phase having an NaZn₁₃-type crystal structure can be formed, contrary to this, when the metallographic structure has a coarse grain size of 20 μm or more, a single phase of the NaZn₁₃-type crystal structure cannot be formed even when homogenizing heat treatment is performed, which shows that e some different phases remains.

Such a different phase does not show magnetocaloric effect and a magnetostriction phenomenon, and the presence of a different phase sometimes lead to the possible adversely affects the exhibition of magnetocaloric effect and a magnetostriction phenomenon. Accordingly, for high-yield manufacturing the bulk material of an La(FeₓSi₁₋ₓ)₁₃ compound (provided that 0.80≦x≦0.90) or an La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio) having an NaZn₁₃-type crystal structure that is single phase and homogeneous in composition, it is effective to use an base alloy having a fine metallographic structure of the grain size of 20 μm or less.

What is claimed is:

1. An alloy material comprising of a plurality of phases different in composition, the grain size of each phase being 20 μm or less, and the composition as a whole being equal to an NaZn₁₃-type La(FeₓSi₁₋ₓ)₁₃ compound (provided that 0.80≦x≦0.90) or an La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio).

2. The magnetic material as claimed in claim 1, which is a bulk material and the minimum value of the outside dimension of the bulk material is 1.0 mm or more.

3. A method for manufacturing a magnetic material using, as a base material, a material comprising of a plurality of phases different in composition, the grain size of each phase being 20 μm or less, and the composition as a whole being equal to an NaZn₁₃ type La(FeₓSi₁₋ₓ)₁₃ compound (provided that 0.80≦x≦0.90), or an La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio), which comprises a homogenizing heat treatment process of heating the base material in vacuo or in inert gas to make a phase of the NaZn₁₃-type crystal structure.

4. The method for manufacturing the magnetic material as claimed in claim 3, which has a process of quenching the magnetic material in a deoxidation atmosphere after the homogenizing heat treatment process.

5. A method for manufacturing a magnetic material comprising a melting process of melting, in a high-frequency induction melting furnace, a raw material of elements prepared in a composition as a whole equal to an NaZn₁₃ type La(FeₓSi₁₋ₓ)₁₃ compound (provided that 0.80≦x≦0.90), or an La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio),
a casting process of casting a molten metal obtained in the preceding process and quenching the molten metal to manufacture a cast alloy, and
a homogenizing heat treatment process of heating the cast alloy manufactured in the preceding process at a temperature to make a phase of the NaZn₁₃-type La(Fe_{0.88}Si_{0.12})₁₃ compound.

6. A method for manufacturing a magnetic material comprising a melting process of melting, in a high-frequency induction melting furnace, a raw material of elements prepared in a composition as a whole equal to an NaZn₁₃ type La(FeₓSi₁₋ₓ)₁₃ compound (provided that 0.80≦x≦0.90), or an La_{1-z}R_{z}(FeₓSi_{y}TM_{1-x-y})₁₃ compound obtained by partial substitution of the La(FeₓSi₁₋ₓ)₁₃ compound (provided that R is at least one element of Ce, Pr and Nd, and TM is at least one element of Al, Mn, Co, Ni and Cr, and x, y and z are respectively 0.80≦x≦0.90, 0.10≦y≦0.20, and 0.00≦z≦1.00, in atomic ratio),
a casting process of casting a molten metal obtained in the preceding process and quenching the molten metal to manufacture a cast alloy,
a forming process of cast alloy obtained in the preceding process and shaping the cast alloy into small pieces in the size of 1.0 mm or less,
a homogenizing heat treatment process of heating the small pieces manufactured in the preceding process at a temperature to make a phase of the NaZn₁₃-type La(Fe_{0.88}Si_{0.12})₁₃ compound.

7. The method for manufacturing a magnetic material as claimed in claim 5, wherein melting in the melting process is carried out in an inert gas atmosphere.

8. The method for manufacturing a magnetic material as claimed in claim 6, wherein a casting mold used in the casting process is a copper mold.

9. The method for manufacturing a magnetic material as claimed in claim 8, wherein the shape of magnetic material cast in the casting process is tabular.

10. The method for manufacturing a magnetic material as claimed in claim 8, wherein heat treatment in the homogenizing heat treatment process is carried out in a deoxidation atmosphere.

11. The method for manufacturing a magnetic material as claimed in claim 10, wherein the homogenizing heat treatment process comprises putting the cast alloy in a silica tube, making the inside of the silica tube vacuum atmosphere or inert gas atmosphere, sealing the silica tube, and heat treating the silica tube.

12. The method for manufacturing a magnetic material as claimed in claim 5, wherein the heat-treated cast alloy is cooled rapidly to room temperature in a refrigerant of 0° C. or lower after the homogenizing heat treatment process.

13. The method for manufacturing a magnetic material as claimed in claim 12, wherein the refrigerant is ice water.

14. A magnetic material manufactured according to the manufacturing method as claimed in claim 3.

15. A magnetic material manufactured according to the manufacturing method as claimed in claim 5.

16. A magnetic refrigerant material for magnetic refrigeration manufactured according to the manufacturing method as claimed in claim 3.

17. A magnetic refrigerant material for magnetic refrigeration manufactured according to the manufacturing method as claimed in claim 5.

18. A magnetic refrigerant material for magnetic refrigeration manufactured according to the manufacturing method as claimed in claim 6.

19. A magnetic refrigerator using the material for magnetic refrigerating works as claimed in claim 18.
